(19) United States
(12) Patent Application Publication
(10) Pub. No.: US 2011/0157500 A1
(43) Pub. Date: Jun. 30, 2011

(54) STEREOSCOPIC DISPLAY DEVICE AND STEREOSCOPIC IMAGE DISPLAYING METHOD

(75) Inventors: Ken-Yu Liu, Hsin-Chu (TW); Cheng-Lung Wu, Hsin-Chu (TW); Chao-Yuan Chen, Hsin-Chu (TW); Jenn-Jia Su, Hsin-Chu (TW)

(73) Assignee: AU OPTRONICS CORP., Hsinchu (TW)

(21) Appl. No.: 12/979,056

(22) Filed: Dec. 27, 2010

(30) Foreign Application Priority Data
Dec. 29, 2009 (TW) 098145579

(51) Int. Cl. G02F 1/1335

(52) U.S. Cl. 349/15

(57) ABSTRACT

An exemplary stereoscopic display device includes a backlight module, a display panel, and a polarizer panel. The backlight module provides a light source for the stereoscopic display device. The display panel is used for displaying a received image. The polarizer panel includes a plurality of polarizer elements. The states of the polarizer elements are switched by an ON/OFF operation for switching a polarization angle of the polarizer panel. The ON/OFF operation of the polarizer panel includes an enabled time interval and a disabled time interval. The polarizer elements provide two different polarization angles respectively in the enabled and disabled time intervals. The enabled time interval and the disabled time interval have different time lengths from each other. A stereoscopic image displaying method is also disclosed.

### CROSS-REFERENCE TO RELATED APPLICATIONS

This application is based upon and claims the benefit of priority from the prior Taiwan Patent Application No. 098145579, filed Dec. 29, 2009, the entire contents of which are incorporated herein by reference.

### BACKGROUND

1. Technical Field

The present invention generally relates to stereoscopic display devices and stereoscopic image displaying methods and, particularly to a stereoscopic display device and a stereoscopic image displaying method cooperating with a pair of polarizer glasses.

2. Description of the Related Art

Nowadays, Due to lively stereoscopic images can be provided by stereoscopic display technology, the stereoscopic display technology becomes an important trend of current display technologies. In a spatial 3D/stereoscopic display technology associated with the prior art, a display panel displays two groups of images respectively viewed by the left eye and the right eye of a viewer. The left-eye view image is only allowed to enter into the viewer's left eye, and the right-eye view image is only allowed to enter into the viewer's right eye. However, the display panel has to display the two groups of images at the same time, a resolution of the display panel may be decreased to 50%, and thus the display panel in the prior art has a disadvantage of low resolution.

Until now, a scanning retarder type 3D technology has been proposed, in which, two independent images for two eyes of viewer are discriminated by a time difference existed therebetween. A pairs of polarizer glasses cooperating with a polarizer panel are used for achieving the mechanism of discriminating left-eye view and right-eye view images. In detail, referring to FIG. 1, showing a schematic operation diagram of a stereoscopic display device in the prior art. The conventional stereoscopic display device includes a backlight module 10, a display panel 12 and a polarizer panel 14. When displaying an image, the display panel 12 displays the predetermined image in a scanning mode/manner. The polarizer panel 14 and the display panel 12 synchronously scan the image and switch a polarization angle of the image, so as to alternately display a left-eye view image 18 for being entered into the left eye of the viewer and a right-eye view image 19 for being entered into the right eye of the viewer. When viewing the images, the viewer wears a pair of polarizer glasses 20 for watching the left-eye view image 18 through a left-eye glass of the polarizer glasses 20 and watching the right-eye view image 19 through a right-eye glass of the polarizer glasses 20.

Still referring to FIG. 1, FIG. 1 shows a process of the display panel 12 displaying a whole image frame by an order along a direction denoted by the rounded arrow in FIG. 1, wherein the whole image frame includes a left-eye view image frame and a right-eye view image frame. The top half of FIG. 1 shows that display panel 12 continuously and progressively scans the left-eye view image 18, and the polarizer panel 14 scans synchronously with the display panel 12. The polarizer panel 14 has two given polarization modes, wherein one of the given polarization modes always corresponds to the left-eye view image 18, and the other one of the given polarization modes always corresponds to the right-eye view image 19. The bottom half of FIG. 1 shows that display panel 12 continuously and progressively scans the right-eye view image 19, and likewise, the polarizer panel 14 scans synchronously with the display panel 12.

However, due to the polarizer panel 14 is used for adjusting the polarization state of an image, and the left-eye view image 18 and the right-eye view image 19 are respectively corresponding to two different polarization modes, thus the polarizer panel 14 should switch the two polarization modes for providing the left-eye view and right-eye view images. The operating state of the polarizer panel 14 is switched between on-state and off-state, so as to alternately display the left-eye view image 18 and the right-eye view image 19. Since the switch-on and switch-off response times of the polarizer panel 14 are not the same with each other, that is, the switch-on response time (Ton) and switch-off response time (Toff) of liquid crystal molecules of the polarizer panel 14 are not the same with each other. Therefore, a correct signals and light leakage behavior viewed by the left eye of the viewer are not the same with that viewed by the right eye of the viewer, which causes a difference between crosstalk levels viewed by the left and right eyes, so that the left-eye view image and the right-eye view image lose balance. As a result, the quality of the stereoscopic images is degraded.

Referring to FIG. 2, showing schematic waveform diagrams in the process of the polarizer panel 14 scanning the left-eye view image. Herein, for explanation, the polarization mode corresponding to the left eye is exemplarily taken as a polarization angle of the polarizer panel 14 being in the switch-on state. In FIG. 2, the waveform A represents an image signal displayed by the display panel 12. The waveform B represents a response curve of the polarizer panel 14 for the left-eye view image signal. The waveform C represents a right/correct signal formed after the image signal passing through the polarizer panel 14. The waveform D represents a wrong signal formed after the image signal passing through the polarizer panel 14, that is, a light leakage signal/behavior. In FIG. 2, the switch-on and switch-off response times of the display panel 12 are exemplarily faster than that of the polarizer panel 14 respectively. In FIG. 2, the four frame-sequence (frame-timing) diagrams from top to bottom respectively are: the frame-sequence diagram of the display panel 12 displaying a white (bright) left-eye view signal and a black (dark) right-eye view signal and the polarizer panel 14 being switch-on first and then switch-off, the frame-sequence diagram of the display panel 12 displaying a black (dark) left-eye view signal and a white (bright) right-eye view signal and the polarizer panel 14 being switch-on first and then switch-off, the frame-sequence diagram of a right/correct signal formed after the image passing through the polarizer panel 14, and the frame-sequence diagram of a wrong signal formed after the image passing through the polarizer panel 14. In FIG. 2, each two frames are defined as a duty cycle in each of the frame-sequence diagrams.

Referring to FIG. 3, showing schematic waveform diagrams in the process of the polarizer panel 14 scanning the right-eye view image. Herein, for explanation, the polarization mode corresponding to the right eye is exemplarily taken as a polarization angle of the polarizer panel 14 being in the switch-off state. In FIG. 3, the waveform A represents the image signal displayed by the display panel 12. The waveform E represents a response curve of the polarizer panel 14 for the right-eye view image signal. The waveform F represents a right/correct signal formed after the image signal passing through the polarizer panel 14. The waveform G represents a wrong signal formed after the image signal passing through the polarizer panel 14, that is, a light leakage signal. In FIG. 3, the switch-on and switch-off response times of the display panel 12 are exemplarily faster than that of the polarizer panel 14 respectively. In FIG. 3, the four frame-sequence diagrams from top to bottom respectively are: the frame-sequence diagram of the display panel 12 displaying a white (bright) right-eye view signal and a black (dark) left-eye view signal and the polarizer panel 14 being switch-off first and then switch-on, the frame-sequence diagram of the display panel 12 displaying a black (dark) right-eye view signal and a white (bright) left-eye view signal and the polarizer panel 14 being switch-off first and then switch-on, the frame-sequence diagram of a right/correct signal formed after the image passing through the polarizer panel 14, and the frame-sequence diagram of a wrong signal formed after the image passing through the polarizer panel 14. In FIG. 3, each two frames are defined as a duty cycle in each of the frame-sequence diagrams.

The crosstalk level is defined as a ratio of a brightness value of the wrong signal and another brightness value of the right/correct signal. It can be obtained from the waveforms shown in FIG. 2 and FIG. 3, the crosstalk level of the right-eye view signal received by the polarizer glasses 20 is obviously larger than the crosstalk level of the left-eye view signal received by the polarizer glasses 20. It may easily cause the images respectively viewed by the left and right eyes to occur adverse phenomenon of ghost image or halo effect. Thus, the quality of the stereoscopic image is reduced.

### BRIEF SUMMARY

Accordingly, the present invention is to provide a stereoscopic display device that can achieve the balance between a left-eye view signal crosstalk level and a right-eye view signal crosstalk level, and thus improve an image quality.

The present invention further is to provide a displaying method of the above stereoscopic display device.

The present invention still further is to provide a stereoscopic image displaying method that can achieve the balance between a left-eye view signal crosstalk level and a right-eye view signal crosstalk level, and thereby improve an image quality.

In a first aspect, a stereoscopic display device includes a backlight module, a display panel and a polarizer panel. The backlight module provides a light source for the stereoscopic display device. The display panel is used for displaying a received image. The polarizer panel includes a plurality of polarizer elements. The polarizer panel switches a polarization angle thereof by changing states of the polarizer elements through an ON/OFF operation. Moreover, the ON/OFF operation of the polarizer panel 14 includes an enabled time interval and a disable time interval. The polarizer elements of the polarizer panel provide two different polarization angles respectively in the enabled and disabled time intervals. The enabled time interval and the disabled time interval have different time lengths from each other.

According to the first aspect, the stereoscopic display device further includes a control switching module, the control switching module is for generating a switching signal to the polarizer panel for controlling the ON/OFF operation of the polarizer panel.

In a second aspect, a displaying method of a stereoscopic display device is disclosed. The stereoscopic display device includes a display panel, a polarizer panel and a control switching module. The polarizer panel includes a plurality of polarizer elements and switches a polarization angle thereof by changing states of the polarizer elements through an ON/OFF operation. The ON/OFF operation of the polarizer panel includes an enabled time interval and a disabled time interval. The displaying method includes the following steps of: enabling the display panel to display a received image; and enabling the control switching module to generate a switching signal for controlling the ON/OFF operation of the polarizer panel. The enabled time interval and the disabled time interval have different time lengths from each other.

In a third aspect, a stereoscopic image displaying method includes the following steps of: alternately providing a plurality of images on a display panel; and periodically switching polarization angles of the images provided on the display panel. Herein, each switching period of the polarization angles includes a process of switching a first predetermined polarization angle to a second predetermined polarization angle, and then switching the second predetermined polarization angle back to the first predetermined polarization angle. A time length of each switching period is an integer multiple of another time length used by any one of the images. In addition, a time interval begins from a time point of initially switching the first predetermined polarization angle to the second predetermined polarization angle until another time point of initially switching the second predetermined polarization angle back to the first predetermined polarization angle is defined as a first time interval. A time interval begins a time point of initially switching the second predetermined polarization angle to the first predetermined polarization angle until another time point of initially switching the first predetermined polarization angle back to the second predetermined polarization angle is defined as a second time interval. The first time interval and the second time interval have different time lengths from each other.

The stereoscopic display device and the displaying method thereof associated with the present invention adjust the ratio of odd-frame time interval to even-frame time interval of the polarizer panel, to achieve the purpose of adjusting the right/correct signal and the wrong signal of the left and right eyes. That is, the left-eye and right-eye crosstalk levels are approximately close to each other through unbalanced operation time intervals for the left and right eyes. Thus, the images respectively entered into the left and right eyes can be balanced effectively to each other, the adverse phenomenon of ghost image and/or halo effect in the prior art can be avoided/suppressed, and the quality of the stereoscopic image is improved consequently.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic operation diagram of a stereoscopic display device in the prior art;

FIG. 2 shows schematic waveform diagrams in the process of the polarizer panel scanning a left-eye view image in the prior art;

FIG. 3 shows schematic waveform diagrams in the process of the polarizer panel scanning a right-eye view image in the prior art;

FIG. 4 shows a schematic operation diagram of an stereoscopic display device in accordance with an embodiment of the present invention;

FIG. 5 shows schematic waveform diagrams in the process of the polarizer panel scanning a left-eye view image in accordance with an embodiment of the present invention;

FIG. 6 shows schematic waveform diagrams in the process of the polarizer panel scanning a right-eye view image in accordance with an embodiment of the present invention;

FIG. 7 shows a flowchart of a displaying method of the stereoscopic display device in accordance with an embodiment of the present invention; and

FIG. 8 shows a flowchart of a stereoscopic image displaying method in accordance with an embodiment of the present invention.

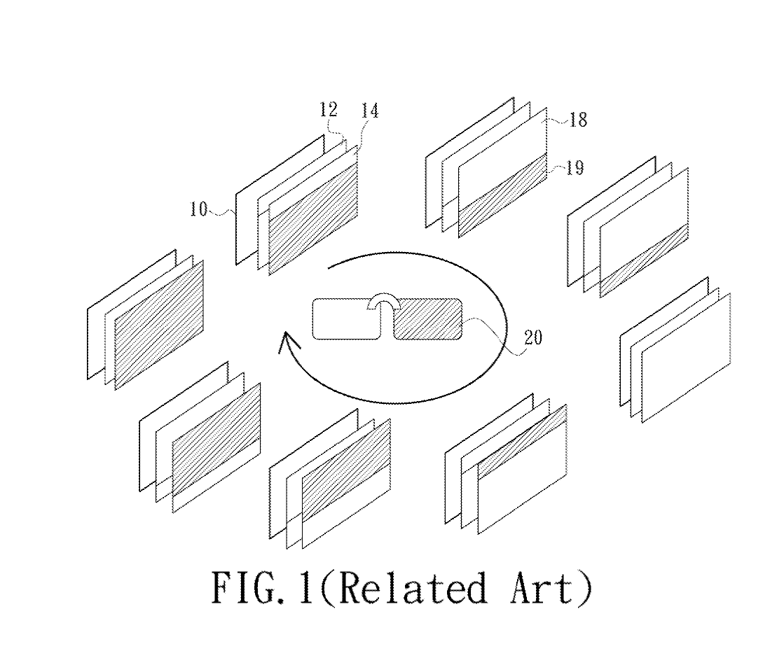

### DETAILED DESCRIPTION

For providing a further understanding of the present invention for one skilled in the art, the accompanying exemplary embodiments together with the drawings are particularized to explain the principles and effects of the invention.

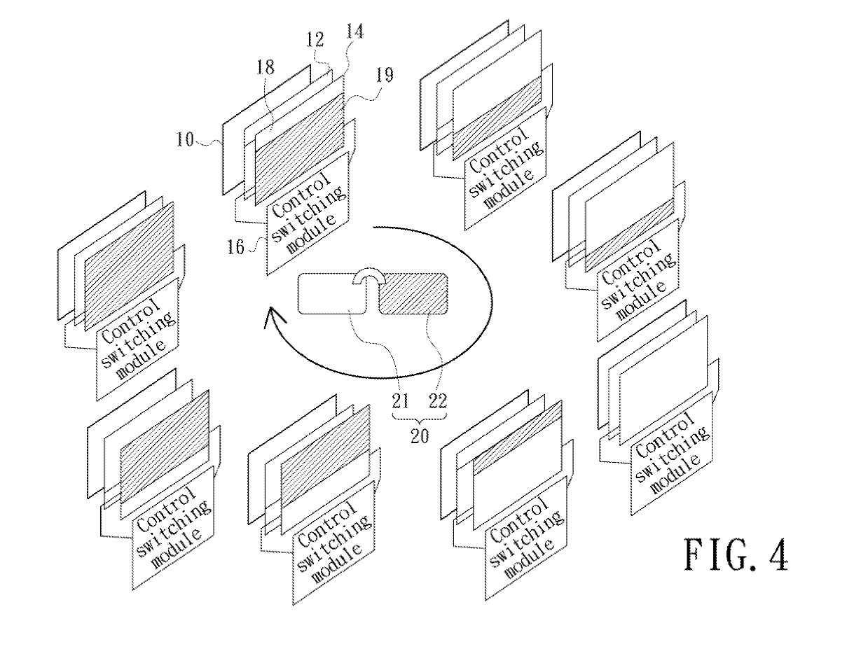

Referring to FIG. 4, showing a schematic operation diagram of a stereoscopic display device in accordance with an embodiment of the present invention. As illustrated in FIG. 4, the stereoscopic display device in accordance with the present invention includes a backlight module 10, a display panel 12, a polarizer panel 14 and a control switching module 16.

In the illustrated embodiment, the display panel 12 is exemplarily a liquid crystal display panel. Thus, the stereoscopic display device has the backlight module 10 equipped therewith for providing a light source required for the display panel 12. The backlight module 10 is arranged at a side of the display panel 12. The backlight module 10 can be a conventional always-on type backlight module or a scanning-type backlight module. The display panel 12 in accordance with the present invention is not limit to be a liquid crystal display panel, but also can be another kind of display panel refreshing images by scanning manner, such as a plasma display panel, an electroluminescent display panel (ELD), a cathode ray tube (CRT) display panel, and so on. The display panel 12 generally is composed of a pair of transparent substrates (not shown) disposed opposite to each other and a display medium sandwiched between the pair of transparent substrates.

In the illustrated embodiment, one of the pair of the transparent substrates includes an active layer formed on a surface thereof. The active layer includes a plurality of pixel areas/regions arranged in array. Each of the pixel areas includes a thin film transistor (TFT), and a signal line and a pixel electrode electronically/electrically connected to the TFT. A material of the display medium includes liquid a crystal material or the other suitable material. In addition, the other one of the pair of the transparent substrate has a coating layer configured on a surface thereof. A material of the coating layer includes a color filter layer, a transparent electrode layer, other suitable material, or a stacked layer formed by at least two of the above materials.

The display panel 12 is electronically connected to an image processor (not shown) and for displaying an image signal received from the image processor. The polarizer panel 14 is arranged at the other side of the display panel 12 facing away the backlight module 10. The polarizer panel 14 includes a plurality of polarizer elements and switches a polarization angle thereof by changing states of the polarizer elements through an ON/OFF operation. In the illustrated embodiment, the polarizer panel 14 is a liquid crystal polarizer panel, and the polarizer elements are liquid crystal molecules.

The control switching module 16 is for generating a switching signal to the polarizer panel 14 to control the ON/OFF operation of the polarizer panel 14. Herein, the ON/OFF operation of the polarizer panel 14 includes an enabled time interval and a disabled time interval. The polarizer elements of the polarizer panel 14 provide two different polarization angles respectively in the enabled and disabled time intervals. The enabled time interval and the disabled time interval have different time lengths from each other. In the enabled time interval, the polarizer panel 14 has a first polarization angle to display a left-eye view image 18. In the disabled time interval, the polarizer panel 14 has a second polarization angle to display a right-eye view image 19. Thus, the left-eye view image 18 and the right-eye view image 19 are alternately displayed. The control switching module 16 adjusts the time lengths of the enabled time interval and the disabled time interval by way of adjusting the switching signal, so as to adjust the right/correct signal and light leakage behavior formed after the image signal passing through the polarizer panel 14.

Besides, in the illustrated embodiment, the stereoscopic display device further is equipped with a pair of polarizer glasses 20. The images from the stereoscopic display device generally is needed to put on the polarizer glasses 20, so that images with different polarization angles can respectively enter into the left and right eyes and thereby realizing a stereoscopic display effect. The polarizer glasses 20 include two pieces of polarizer glasses, that is, a left-eye polarizer glass 21 and a right-eye polarizer glass 22. In the illustrated embodiment, the left-eye polarizer glass 21 allows the image signal with the first polarization angle to pass therethrough and blocks the image signal with the second polarization angle, the right-eye polarizer glass 22 allows the image signal with the second polarization angle to pass therethrough and blocks the image signal with the first polarization angle. The control switching module 16 adjusts the switching signal to make the left-eye crosstalk level be approximately close to the right-eye crosstalk level, when an image provided by the stereoscopic display device is watched by the viewer through the polarizer glasses 20.

The top half of FIG. 4 shows that display panel 12 continuously and progressively scans the left-eye view image 18, and the polarizer panel 14 scans substantially synchronized with the display panel 12 and switches a polarization angle of the image. In the enabled time interval, the polarizer panel 14 has a first polarization angle to display the left-eye view image 18. In the disabled time interval, the polarizer panel 14 has a second polarization angle to display the right-eye view image 19. Thus, the left-eye view image 18 and the right-eye view image 19 are alternately displayed. Likewise, the bottom half of FIG. 4 shows that display panel 12 continuously and progressively scans the right-eye view image 19, and the polarizer panel 14 scans substantially synchronized with the display panel 12 and switches the polarization angel of the image.

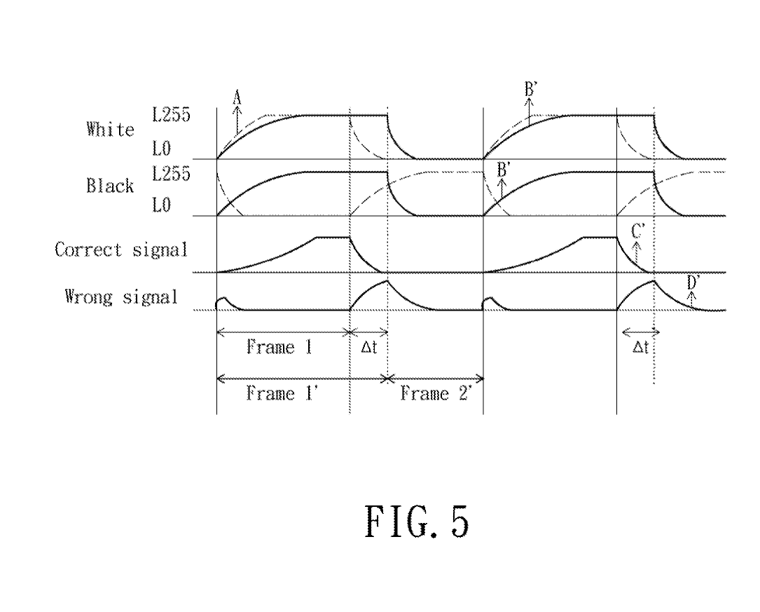

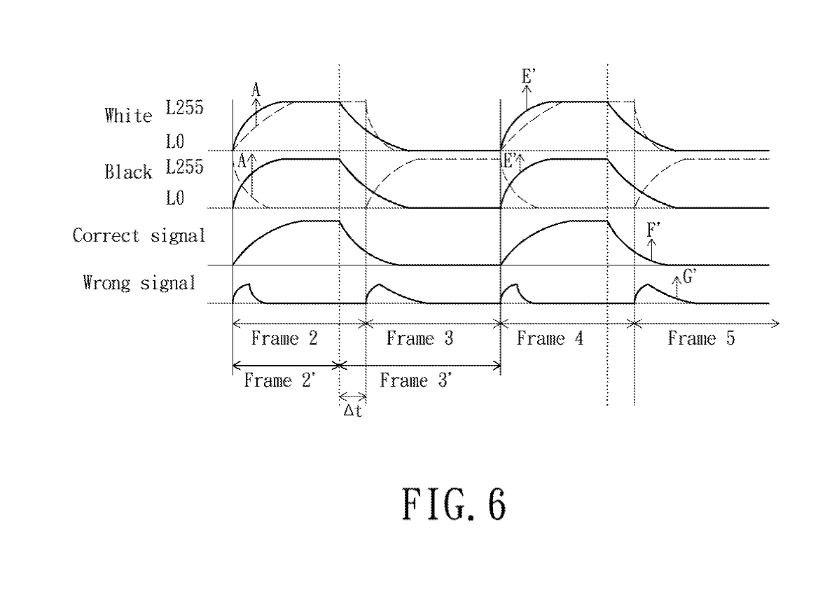

Referring to FIGS. 5 and 6, FIG. 5 showing schematic waveform diagrams in the process of the polarizer panel scanning the left-eye view image. Herein, for explanation, a polarization mode corresponding to the left eye is exemplarily taken as a polarization angle of the polarizer panel 14 being in the switch-on state. In FIG. 5, the waveform A represents an image signal displayed by the display panel 12. The waveform B′ represents a response curve of the polarizer panel 14 for the switching signal. The waveform C′ represents a right/correct signal generated after the waveform A passing through the polarizer panel 14. The waveform D′ represents a wrong signal generated after the waveform A passing through the polarizer panel 14, that is, a light leakage signal. It needs to be pointed out that, in the illustrated embodiment, the switch-on state of the polarizer panel 14 is that switching the polarization angle of the image to be the foregoing first polarization angle and thereby allowing the image to pass through the left-eye polarizer glass 21 of the glasses 20 and then enter into the left eye. In contrast, the switch-off state of the polarizer panel 14 is that switching the polarization angle of the image to be the foregoing second polarization angle and thereby allowing the image to pass through the right-eye polarizer glass 22 of the glasses 20 and enter into the right eye.

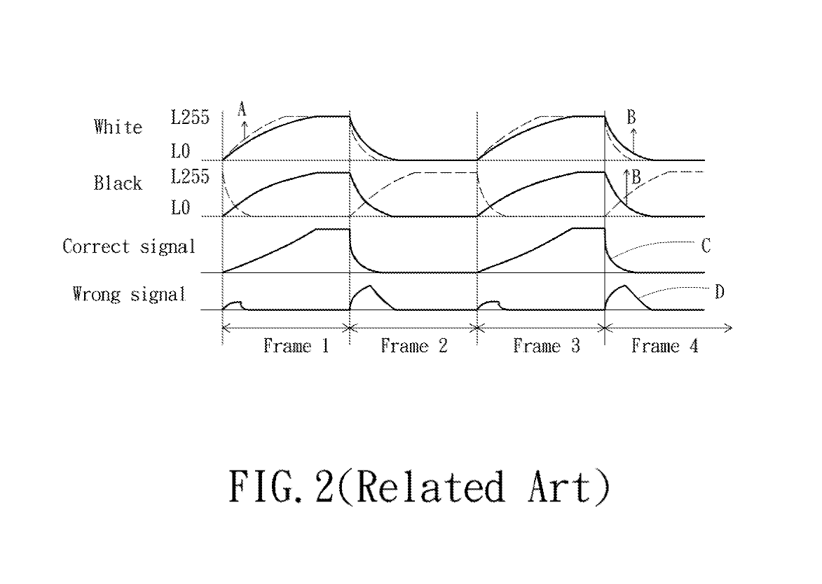

In FIG. 5, the four frame-sequence diagrams from top to bottom respectively are that: the frame-sequence diagram of the display panel 12 displaying a white (bright) left-eye view signal and a black (dark) right-eye view signal and the polarizer panel 14 being switch-on first and then switch-off, the frame-sequence diagram of the display panel 12 displaying a black (dark) left-eye view signal and a white (bright) right-eye view signal and the polarizer panel 14 being switch-on first and then switch-off, the frame-sequence diagram of a right/correct signal generated after the image passing through the polarizer panel 14, and the frame-sequence diagram of a wrong signal generated after the image passing through the polarizer panel 14. In FIG. 5, each two frames are defined as a duty cycle in each of the frame-sequence diagrams. In the illustrated embodiment, in each duty cycle, the signal of odd frame is corresponding to the switch-on state of the polarizer panel 14, and the signal of even frame is corresponding to the switch-off state of the polarizer panel 14. The difference between FIG. 5 and FIG. 2 is that, the enabled time interval (corresponding to the switch-on state) of the polarizer panel 14 in FIG. 5 is longer than the enabled time interval of the polarizer panel 14 in FIG. 2 with a time length of Δt. Correspondingly, the disabled time interval (corresponding to the switch-off state) of the polarizer panel 14 in FIG. 5 is shorter than the disabled time interval of the polarizer panel 14 in FIG. 2 with the time length of Δt.

Referring to FIG. 6, showing schematic waveform diagrams in the process of the polarizer panel 14 scanning the right-eye view image according to another embodiment. Herein, for explanation, the polarization mode corresponding to the right eye is exemplarily taken as a polarization angle of the polarizer panel 14 being in the switch-off state. In FIG. 6, the waveform A represents an image signal displayed by the display panel 12. The waveform E′ represents a response curve of the polarizer panel 14 to the switching signal. The waveform F′ represents a right/correct signal generated after the waveform A passing through the polarizer panel 14. The waveform G′ represents a wrong signal generated after the waveform A passing through the polarizer panel 14, that is, a light leakage signal. It needs to be pointed out that, in the illustrated embodiment, the switch-off state of the polarizer panel 14 is that switching the polarization angel of the image to be the foregoing second polarization angel so that the image can pass through the right-eye glass 22 of the polarizer glasses 20 and the enter into the right eye. In contrast, the switch-on state of the polarizer panel 14 is that switching the polarization angel of the image to be the foregoing first polarization angel so that the image can pass through the left-eye glass 21 of the polarizer glasses 20 and then enter in the left eye.

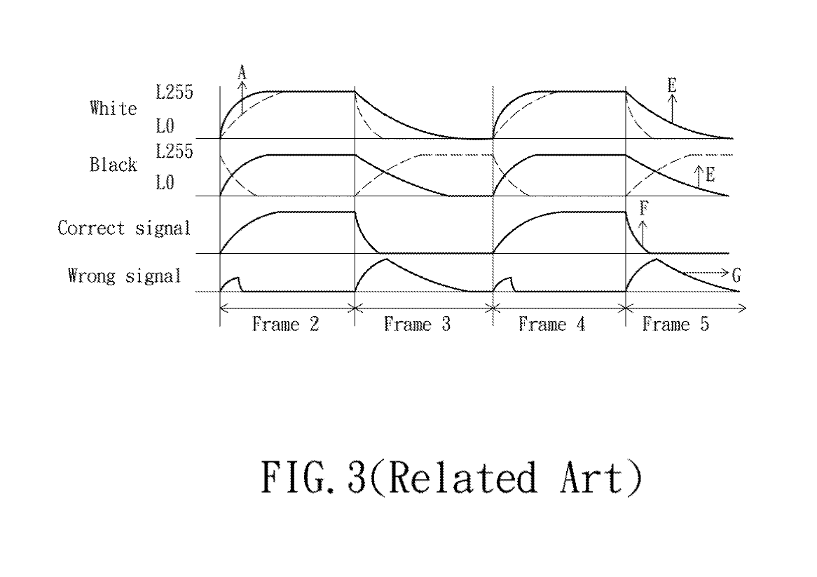

In FIG. 6, the four frame-sequence diagrams from top to bottom respectively are that: the frame-sequence diagram of the display panel 12 displaying a white (bright) right signal and a black (dark) left signal and the polarizer panel 14 being switch-off first and then switch-on, the frame-sequence diagram of the display panel 12 displaying a black (dark) right signal and a white (bright) left signal and the polarizer panel 14 being switch-off first and then switch-on, the frame-sequence diagram of a right/correct signal generated after the image passing through the polarizer panel 14, and the frame-sequence diagram of a wrong signal generated after the image passing through the polarizer panel 14. Similarly, in the illustrated embodiment, each two frames are defined as a duty cycle in each of the frame-sequence diagrams. Herein, in each duty cycle, the signal of odd frame is corresponding to the switch-off state of the polarizer panel 14, and the signal of even frame is corresponding to the switch-on state of the polarizer panel 14. The difference between FIG. 6 and FIG. 3 is that, the disabled time interval (corresponding to the switch-off state in each odd frame) of the polarizer panel 14 in FIG. 6 is shorter than the disabled time interval of the polarizer panel 14 in FIG. 3 with a time length of Δt, correspondingly, the enabled time interval (corresponding to the switch-on state in each even frame) of the polarizer panel 14 in FIG. 6 is longer than the enabled time interval of the polarizer panel 14 in FIG. 3 with the time length of Δt.

It can be obtained from the waveforms shown in FIG. 5 and FIG. 6, compared with the waveforms shown in FIGS. 2 and 3, the crosstalk levels of the left-eye view signal and the right-eye view signal received by the polarizer glasses 20 as shown in FIGS. 5 and 6 are approximately close to each other. Thus, the images respectively entered into the left and right eyes can be balanced effectively, the adverse phenomenon of ghost image or halo effect associated with the prior art can be avoided/suppressed, and thus the quality of the stereoscopic image can be improved.

It should be understood that, in the above embodiments, it only takes the example with that the switch-on speed and the switch-off speed of the display panel 12 respectively are faster than that of the polarizer panel 14 (as shown in FIGS. 5 and 6). Similarly, if the switch-on speed and the switch-off speed of the display panel 12 respectively are slower than that of the polarizer panel 14, the enable time interval or the disable time interval of the polarizer panel 14 can also be controlled to be prolonged or shorten with a suitable time length, so as to reduce the light leakage behavior of the polarizer panel 14.

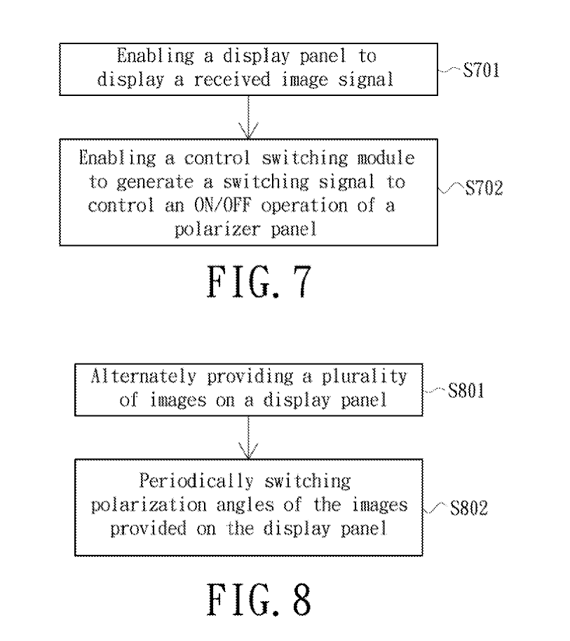

In short, referring to FIG. 7, the present invention further discloses a displaying method of the above stereoscopic display device. In the displaying method, the display panel 14 is enabled to display a received image signal (step S701). The control switching module 16 is enabled to generate a switching signal to control the ON/OFF operation of the polarizer panel 14 (step S702). The enabled time interval and the disabled time interval in the ON/OFF operation have different time lengths from each other.

From another point of view, referring to FIG. 8, the displaying method of the above stereoscopic display device would include the steps as described as follows.

A plurality of images are alternately provided/displayed on the display panel 12 (step S801), and the polarization angles of the images provided on the display panel 12 are periodically switched (step S802).

Herein, each switching period of the polarization angles includes the process of switching the foregoing first predetermined polarization angle to be the second predetermined polarization angle and then switching the second predetermined polarization angle back to the first predetermined polarization angle. The time length of each switching period is an integer multiple of the time length used by one of the images. In addition, a first time interval (corresponding to one of the above enabled and disabled time intervals) begins from a time point of initially switching the first predetermined polarization angle to be the second predetermined polarization angle until another time point of initially switching the second predetermined polarization angle back to the first predetermined polarization angle. A second time interval (corresponding to the other one of the above disabled and enabled time interval) begins from a time point of initially switching the second predetermined polarization angle to be the first predetermined polarization angle until another time point of initially switching the first predetermined polarization angle back to the second predetermined polarization angle. Herein, the first time interval and the second time interval have different time lengths from each other. The time lengths of both the first time interval and the second time interval can be adjusted.

As stated above, the present invention utilizes the polarizer panel 14 and the display panel 12 being substantially synchronized with each other and the polarizer panel 12 being alternately switched in the switch-on mode and switch-off mode to provide image signals for the respective left and right eyes. In addition, the present invention utilizes adjusting a ratio between the odd frame scanning time and the even frame scanning time to adjust the right signals and the wrong signals for the left and right eyes, that is, the crosstalk levels respectively for the left and right eyes are achieved to be approximately close to each other through the unbalanced operation time intervals. Thus, the images respectively entered into the left and right eyes can be balanced effectively, the adverse phenomenon of ghost image or halo effect in the prior art can be avoided/suppressed, and the quality of the stereoscopic image is improved consequently.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A stereoscopic display device, comprising:
a backlight module, for providing a light source for the stereoscopic display device;
a display panel, for displaying a received image; and
a polarizer panel, comprising a plurality of polarizer elements and switching a polarization angle of the polarizer panel by changing states of the polarizer elements through an ON/OFF operation;
wherein the ON/OFF operation of the polarizer panel comprises an enabled time interval and a disabled time interval, the polarizer elements provide different polarization angles respectively in the enabled time interval and the disabled time interval, and the enabled time interval and the disenabled time interval have different time lengths.

2. The stereoscopic display device as claimed in claim 1, further comprising a control switching module, wherein the control switching module is for generating a switching signal to the polarizer panel for controlling the ON/OFF operation of the polarizer panel.

3. The stereoscopic display device as claimed in claim 2, wherein the control switching module adjusts the time lengths of the enabled time interval and the disabled time interval by adjusting the switching signal, and thereby right signals and light leakage signals formed after the received image passing through the polarizer panel are adjusted.

4. The stereoscopic display device as claimed in claim 3, wherein the control switching module adjusts the switching signal to make crosstalk levels of respective left-eye view signal and right-eye view signal provided to a polarizer glasses matched with the stereoscopic display device being approximately close to each other.

5. The stereoscopic display device as claimed in claim 1, wherein the polarizer panel and the backlight module are arranged at two opposite sides of the display panel.

6. The stereoscopic display device as claimed in claim 1, wherein the display panel is a liquid crystal display panel.

7. The stereoscopic display device as claimed in claim 1, wherein the polarizer panel is a liquid crystal polarizer panel, and the polarizer elements are liquid crystal molecules.

8. A displaying method of a stereoscopic display device, the stereoscopic display device comprising a display panel, a polarizer panel and a control switching module, the polarizer panel comprising a plurality of polarizer elements and switching a polarization angle of the polarizer panel by changing states of the polarizer elements through an ON/OFF operation, the ON/OFF operation of the polarizer panel comprising an enabled time interval and a disabled time interval, the displaying method comprising:
enabling the display panel to display a received image; and
enabling the control switching module to generate a switching signal to control the ON/OFF operation of the polarizer panel;
wherein the enabled time interval and the disabled time interval in the ON/OFF operation have different time lengths.

9. The displaying method as claimed in claim 8, wherein the step of enabling the control switching module to generate a switching signal to control the ON/OFF operation of the polarizer panel comprises:
adjusting the time lengths of the enabled time interval and the disabled time interval to make crosstalk levels of respective left-eye view signal and right-eye view signal provided to a polarizer glasses matched with the stereoscopic display device being approximately close to each other.

10. The displaying method as claimed in claim 8, further comprising:
providing a light source for the display panel.

11. A stereoscopic image displaying method, comprising:
alternately providing a plurality of images on a display panel; and
periodically switching polarization angles of the images provided on the display panel;
wherein each switching polarization angles of the images comprises a step of switching a first predetermined polarization angle to a second predetermined polarization angle and then switching the second predetermined polarization angle back to the first predetermined polarization angle; a time length of each switching period is an integer multiple of another time length used by one of the images;
wherein a time interval beginning from a time point of initially switching the first predetermined polarization angle to the second predetermined polarization angle until another time point of initially switching the second predetermined polarization angle back to the first predetermined polarization angle is defined as a first time interval, a time interval beginning from a time point of initially switching the second predetermined polarization angle to the first predetermined polarization angle until another time point of initially switching the first predetermined polarization angle back to the second predetermined polarization angle is defined as a second time interval, and the first time interval and the second time interval have different time lengths.

12. The stereoscopic image displaying method as claimed in claim 11, wherein the time lengths of the first time interval and the second time interval are adjustable.
